(19) United States
(12) Patent Application Publication
(10) Pub. No.: US 2022/0034754 A1
(43) Pub. Date: Feb. 3, 2022

(54) VEHICLE INSPECTION SYSTEM

(71) Applicant: HONDA MOTOR CO., LTD., Minato-ku, Tokyo (JP)

(72) Inventors: Kento Aono, Haga-gun, Tochigi-ken (JP); Kenichiro Kurai, Haga-gun, Tochigi-ken (JP)

(21) Appl. No.: 17/277,320

(22) PCT Filed: Aug. 20, 2019
(86) PCT No.: PCT/JP2019/032340

§ 371 Date: Mar. 18, 2021

(30) Foreign Application Priority Data
Sep. 21, 2018 (JP) 2018-177983

(51) Int. Cl. G01M 17/007

(52) U.S. Cl. CPC G01M 17/0072

(57) ABSTRACT

Provided is a vehicle inspection system that makes it possible to perform integrated inspection of external sensors, a vehicle control device, and various types of actuators. The vehicle inspection system is provided with: a simulator for reproducing virtual information that imitates external environment information; a plurality of information output devices that are provided to each of a plurality of external sensors and that cause the corresponding external sensors to detect the virtual information reproduced by the simulator; and a bench test device for detecting operation of a vehicle that performs travel control on the basis of the virtual information. The simulator outputs virtual information corresponding to the same virtual external environment to the plurality of information output devices and synchronizes the virtual information output to the plurality of information output devices.

### TECHNICAL FIELD

The present invention relates to a vehicle inspection system that inspects operation of a vehicle that performs travel control on the basis of external environment information detected by a plurality of external environment sensors.

### BACKGROUND ART

Japanese Patent No. 5868550 has disclosed a method of performing an operation test (hereinafter also referred to as inspection) of a vehicle including a plurality of travel environment sensors (hereinafter also referred to as external environment sensors) such as a radar, a LiDAR, and a sonar. In this method, a vehicle including a test control unit actually travels in a test course. The test control unit changes measurement values detected by the external environment sensors in accordance with vehicle environments in a virtual world and outputs the measurement values to a control unit of the vehicle (hereinafter also referred to as vehicle control device). As a result, the vehicle control device performs travel control on the basis of the changed measurement values. Thus, the operation test of the vehicle in the virtual world can be performed independently of the actual test course.

### SUMMARY OF INVENTION

In the method according to Japanese Patent No. 5868550, the vehicle control device and various actuators (actuators for driving, braking, and steering) that are controlled by the vehicle control device are inspected, but the external environment sensors are not inspected. That is to say, the method according to Japanese Patent No. 5868550 cannot perform consistent inspection on the external environment sensors, the vehicle control device, and the various actuators.

The present invention has been made in view of the problem as above, and an object is to provide a vehicle inspection system that can perform consistent inspection on environment sensors, a vehicle control device, and various actuators.

One aspect of the present invention is a vehicle inspection system configured to inspect operation of a vehicle that performs travel control on the basis of external environment information detected by a plurality of external environment sensors, the vehicle inspection system including: a simulator configured to reproduce virtual information simulating the external environment information; a plurality of information output devices provided respectively for the plurality of external environment sensors and configured to cause the respective external environment sensors to detect the virtual information reproduced by the simulator; and a bench test machine configured to detect the operation of the vehicle that performs the travel control on the basis of the virtual information, wherein the simulator is configured to output the virtual information corresponding to the same virtual external environment, to the plurality of information output devices, and configured to synchronize the virtual information to be output to the plurality of information output devices.

According to the present invention, it is possible to perform consistent inspection on the external environment sensors, the vehicle control device, and various actuators provided on a driving device, a braking device, and a steering device.

### BRIEF DESCRIPTION OF DRAWINGS

FIG. 1 is a device configuration diagram of a vehicle to be inspected in a first embodiment;

FIG. 2 is a system configuration diagram of a vehicle inspection system according to the first embodiment;

FIG. 3 is a function block diagram of a simulator;

FIG. 4 is a schematic diagram of a monitor supporting mechanism;

FIG. 5A, FIG. 5B, and FIG. 5C are operation explanatory diagrams of the monitor supporting mechanism;

FIG. 6A is an explanatory diagram of a virtual external environment reproduced by the simulator and FIG. 6B is an explanatory diagram of ideal temporal transition of vehicle speed during the inspection;

FIG. 7 is a schematic diagram of a simulator unit according to a second embodiment; and

FIG. 8A and FIG. 8B are operation explanatory diagrams of the simulator unit.

### DESCRIPTION OF EMBODIMENTS

Preferred embodiments of a vehicle inspection system according to the present invention are hereinafter described in detail with reference to the attached drawings.

### 1. First Embodiment

### 1.1. Vehicle 200

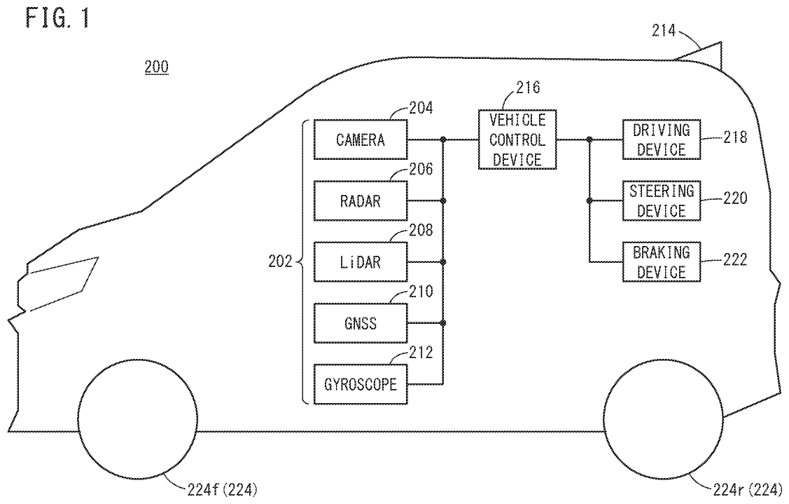

A vehicle 200 to be inspected by a vehicle inspection system 10 is described. Here, it is assumed that the vehicle 200 is an automated driving vehicle (including a fully automated driving vehicle) capable of automatic control of acceleration/deceleration, braking, and steering; however, the vehicle 200 may alternatively be a driving assistance vehicle capable of automatic control of at least one of the acceleration/deceleration, the braking, and the steering. As illustrated in FIG. 1, the vehicle 200 includes a plurality of external environment sensors 202, a vehicle control device 216 that performs travel control on the basis of external environment information detected by the external environment sensors 202, a driving device 218 and a steering device 220 that operate in accordance with an operation instruction output from the vehicle control device 216, a braking device 222, and each wheel 224.

The external environment sensors 202 include one or more cameras 204, one or more radars 206, one or more LiDARs 208, a GNSS 210, and a gyroscope 212. Here, for the convenience of description, it is assumed that the vehicle 200 includes one of each, concerning the aforementioned external environment sensors 202. The camera 204, the radar 206, and the LiDAR 208 detect the external environment information ahead of the vehicle 200.

The vehicle control device 216 is formed by a vehicle control ECU. The vehicle control ECU calculates the acceleration/deceleration, the braking amount, and the steering angle that are optimal in that scene on the basis of the external environment information detected by the external environment sensors 202, and outputs the operation instruction to various control target devices. The driving device 218 includes a driving ECU, and a driving source such as an engine or a driving motor. The driving device 218 generates the driving force for the wheels 224 in accordance with the occupant's operation on an accelerator pedal or the operation instruction output from the vehicle control device 216. The steering device 220 includes an electric power steering system (EPS) ECU and an EPS actuator. The steering device 220 changes the steering angle of the wheels 224 (front wheels 224f) in accordance with the occupant's operation of a steering wheel or the operation instruction output from the vehicle control device 216. The braking device 222 includes a brake ECU and a brake actuator. The braking device 222 generates the braking force for the wheels 224 in accordance with the occupant's operation on a brake pedal or the operation instruction output from the vehicle control device 216.

### 1.2. Vehicle Inspection System 10

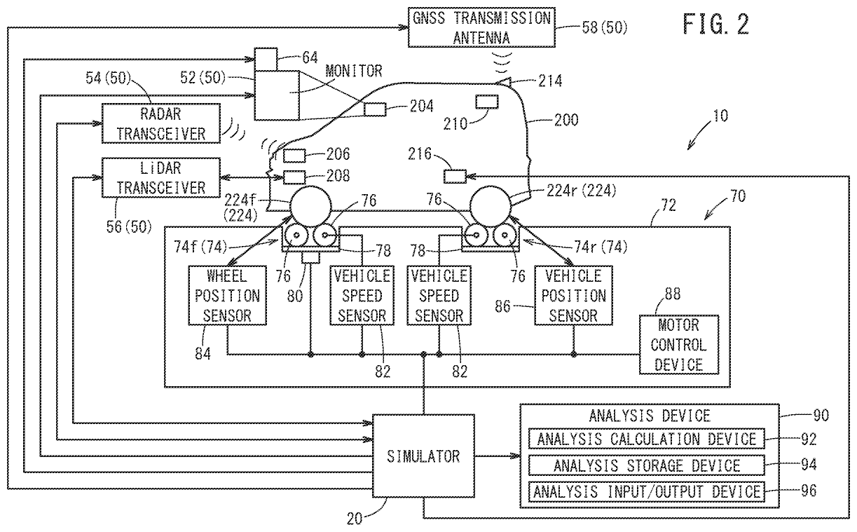

The vehicle inspection system 10 that inspects the operation of the vehicle 200 illustrated in FIG. 1 is described. As illustrated in FIG. 2, the vehicle inspection system 10 includes a simulator 20, a plurality of information output devices 50, a bench test machine 70, and an analysis device 90.

### 1.2.1. Simulator 20

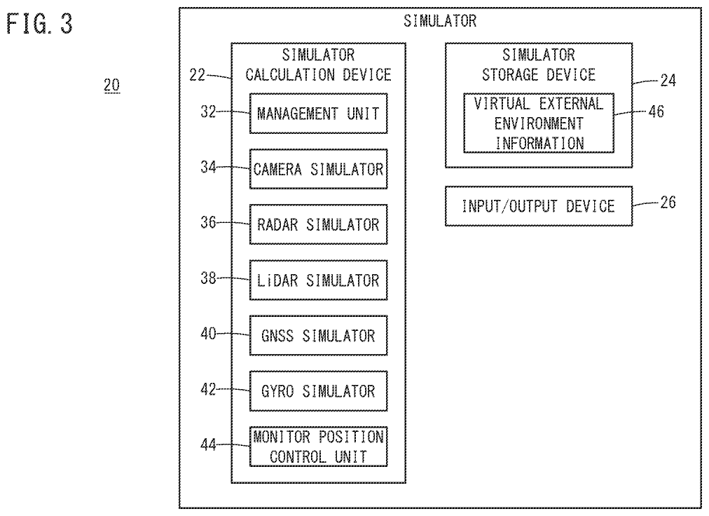

The simulator 20 is formed by a computer, and includes a simulator calculation device 22, a simulator storage device 24, and an input/output device 26 as illustrated in FIG. 3.

The simulator calculation device 22 is formed by a processor such as a CPU. The simulator calculation device 22 achieves various functions by executing programs stored in the simulator storage device 24. Here, the simulator calculation device 22 functions as a management unit 32, a camera simulator 34, a radar simulator 36, a LiDAR simulator 38, a GNSS simulator 40, a gyro simulator 42, and a monitor position control unit 44.

The management unit 32 has a function of managing a process of inspecting the vehicle 200. For example, on the basis of virtual external environment information 46 stored in the simulator storage device 24, the management unit 32 reproduces a virtual external environment with the camera simulator 34, the radar simulator 36, the LiDAR simulator 38, the GNSS simulator 40, and the gyro simulator 42. That is to say, the management unit 32 has a function of performing cooperative control on the simulators 34, 36, 38, 40, and 42 in which the simulators 34, 36, 38, 40, and 42 synchronously reproduce the virtual information corresponding to the same virtual external environment. When the virtual external environment is reproduced, the management unit 32 calculates the virtual travel position of the vehicle 200 in the virtual external environment on the basis of the operation information (vehicle speed V and steering angle θs) of the vehicle 200 output from the bench test machine 70.

The camera simulator 34 has a function of reproducing video information (image information) detected by the camera 204 at a virtual travel position of the vehicle 200. The camera simulator 34 outputs the video information as the virtual information to a monitor (display device) 52.

The radar simulator 36 has a function of reproducing positional information of an object to be detected by the radar 206 at the virtual travel position of the vehicle 200. On the premise that an electric wave emitted from the radar 206 is reflected by the object, the radar simulator 36 calculates a timing at which an electric wave corresponding to the reflection wave is emitted to the radar 206, on the basis of the positional information of the object in the virtual external environment. Then, the radar simulator 36 performs a delaying process for the emission timing after a radar transceiver 54 has detected the electric wave, and outputs the instruction of emitting the electric wave as the virtual information, to the radar transceiver 54.

The LiDAR simulator 38 has a function of reproducing the positional information of an object to be detected by the LiDAR 208 at the virtual travel position of the vehicle 200. On the premise that laser light emitted from the LiDAR 208 is reflected by the object, the LiDAR simulator 38 calculates a timing at which light corresponding to scattering light is emitted to the LiDAR 208, on the basis of the positional information of the object in the virtual external environment. Then, the LiDAR simulator 38 performs a delaying process for the emission timing after a LiDAR transceiver 56 has detected the laser light, and outputs the instruction of emitting the light as the virtual information, to the LiDAR transceiver 56.

The GNSS simulator 40 has a function of reproducing the positional information (longitude and latitude information) of the vehicle 200 that is detected by the GNSS 210 at the virtual travel position of the vehicle 200. The GNSS simulator 40 outputs the positional information as the virtual information, to a GNSS transmission antenna 58.

The gyro simulator 42 has a function of reproducing the operation information (angular speed, angular acceleration, etc.) in a turning direction, generated in the vehicle 200, on the basis of the operation information (vehicle speed V and steering angle θs) of the vehicle 200. The gyro simulator 42 outputs the operation information as the virtual information, to the vehicle control device 216. Thus, in the present embodiment, the gyro simulator 42 does not output the operation information to the gyroscope 212. That is to say, inspection is not performed on the gyroscope 212. The reason is that the gyroscope 212 of the vehicle 200 is configured to detect the operation in the turning direction that is actually generated in the vehicle 200, and it is impossible to inspect the gyroscope 212 on an inspection table 72.

The simulator storage device 24 is formed by a hard disk, a ROM, a RAM, and the like. The simulator storage device 24 stores programs that are executed by the simulator calculation device 22, and the virtual external environment information 46 simulating the external environment information. The virtual external environment information 46 is information that is used to reproduce a series of virtual external environments. In the virtual external environment information 46, information about the initial position of the vehicle 200 in the virtual external environment, the position of each object in the virtual external environment, the behavior of the moving object, and the like is set in advance. The virtual external environment information 46 will be described in the paragraph [1.4.1] below.

The input/output device 26 includes an A/D conversion circuit, a communication interface, a driver, and the like.

### 1.2.2. Information Output Device 50

Back to FIG. 2, the information output device 50 is described. The information output device 50 causes the external environment sensors 202 to detect the virtual information corresponding to the virtual external environment reproduced by the simulator 20. The information output device 50 includes the monitor 52, the radar transceiver 54, the LiDAR transceiver 56, and the GNSS transmission antenna 58.

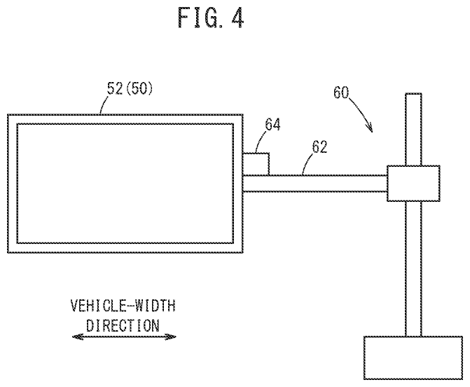

The monitor 52 is disposed to face a lens of the camera 204. The monitor 52 displays the video (image) of the virtual external environment on the basis of the video information output from the camera simulator 34. As illustrated in FIG. 4, the monitor 52 is supported by a monitor supporting mechanism 60. The monitor supporting mechanism 60 includes a monitor motor 64 that moves the monitor 52 in a vehicle width direction along a stay 62 extending in the vehicle width direction. The monitor motor 64 is driven by electric power supplied from the input/output device 26 (driver) of the simulator 20.

The radar transceiver 54 includes a transmission/reception circuit and a directional antenna, and is disposed to face the transmission/reception antenna of the radar 206. The radar transceiver 54 detects electric wave emitted from the transmission/reception antenna of the radar 206, and outputs a detection signal to the radar simulator 36. Then, the radar transceiver 54 emits electric wave toward the transmission/reception antenna of the radar 206 in accordance with the emission instruction output from the radar simulator 36. Note that an electric wave absorber is disposed within an electric-wave irradiation range of the radar 206 in order to prevent the electric wave emitted from the transmission/reception antenna of the radar 206 from being reflected by the radar transceiver 54 or the peripheral object.

The LiDAR transceiver 56 includes a transmission unit (oscillation circuit) and a light reception unit (light reception circuit), and is disposed to face a transmission/reception unit of the LiDAR 208. The LiDAR transceiver 56 detects the laser light emitted from the transmission/reception unit of the LiDAR 208, and outputs the detection signal to the LiDAR simulator 38. Then, the LiDAR transceiver 56 emits the light toward the transmission/reception unit of the LiDAR 208 in accordance with the emission instruction output from the LiDAR simulator 38. Note that a light absorber is disposed within a laser-light irradiation range of the LiDAR 208 in order to prevent scattering light of the laser light emitted from the transmission/reception unit of the LiDAR 208 from being reflected by the LiDAR transceiver 56 or the peripheral object.

The GNSS transmission antenna 58 includes the GNSS transmission antenna 58 and a shielding member that covers this GNSS transmission antenna 58, and is disposed to cover a GNSS reception antenna 214 of the vehicle 200 with the shielding member. The GNSS transmission antenna 58 outputs a quasi-signal (false signal) indicating the position of the vehicle 200 on the basis of the positional information output from the GNSS simulator 40.

### 1.2.3. Bench Test Machine 70

As illustrated in FIG. 2, the bench test machine 70 includes an inspection table 72, receiving devices 74, various sensors (vehicle speed sensor 82, wheel position sensor 84, vehicle position sensor 86), and a motor control device 88. The inspection table 72 is installed on a work floor.

The receiving devices 74 are provided at positions of the wheels 224 (front wheels 224f, rear wheels 224r) of the vehicle 200 placed on the inspection table 72, and serve as a mechanism to receive the operation of the wheels 224 that are placed on the receiving devices 74. A receiving device 74f provided on the side of the front wheels 224f, which serve as steered wheels, includes two rollers 76, a supporting board 78, and a supporting board motor 80. The two rollers 76 support the front wheels 224f from below and are rotatable about an axial line, which is parallel to the vehicle width direction, in accordance with the rotation of the front wheels 224f. The supporting board 78 supports the rollers 76 and is rotatable about an axial line, which is parallel to a vertical direction of the vehicle 200. The supporting board motor 80 rotates the supporting board 78 in a forward direction or a reverse direction. On the other hand, a receiving device 74r provided on the side of the rear wheels 224r includes two rollers 76 and a supporting board 78. The two rollers 76 support the rear wheels 224r from below and are rotatable about an axial line, which is parallel to the vehicle width direction, in accordance with the rotation of the rear wheels 224r. At least one of the receiving device 74f and the receiving device 74r is movable in a front-rear direction in accordance with the wheelbase of the vehicle 200.

The vehicle speed sensor 82 is provided to each of the receiving device 74f and the receiving device 74r in order to be applicable to both the front wheel drive vehicle 200 and the rear wheel drive vehicle 200, and is formed by, for example, a rotary encoder or a resolver. The vehicle speed sensor 82 detects rotation speed r of the roller 76. The rotation speed r corresponds to the vehicle speed V. The wheel position sensor 84 is provided on the side of the front wheels 224f serving as the steered wheels, and is formed by a laser ranging device or the like. The wheel position sensor 84 detects a displacement quantity d1 from the initial position of the front wheels 224f caused by the steering. The displacement quantity d1 corresponds to the steering angle θs of the vehicle 200. The vehicle position sensor 86 is provided at a position where a predetermined portion (for example, rear wheels 224r) can be detected, and is formed by a laser ranging device or the like. The vehicle position sensor 86 detects a positional shift d2 of the predetermined portion (for example, rear wheels 224r) due to the positional shift in the vehicle width direction.

The motor control device 88 is formed by a computer, and includes a calculation device, a storage device, and an input/output device. The calculation device controls the supporting board motor 80 provided to the receiving device 74f by executing the programs stored in the storage device. Specifically, the calculation device calculates a rotation angle θm of the receiving device 74f in accordance with the displacement quantity d1 (steering angle θs). Note that the displacement quantity d1 is affected by the positional shift of the vehicle 200. Therefore, the motor control device 88 adjusts the displacement quantity d1 in accordance with the positional shift d2 of the vehicle 200. The input/output device supplies electric power to the supporting board motor 80 in order to rotate the receiving device 74f by a rotation angle θm.

The bench test machine 70 outputs, to the simulator 20, the operation information of the vehicle 200, that is, the rotation speed r (vehicle speed V) detected by the vehicle speed sensor 82, the displacement quantity d1 (steering angle θs) detected by the wheel position sensor 84, and the positional shift d2 detected by the vehicle position sensor 86.

### 1.2.4. Analysis Device 90

The analysis device 90 is formed by a computer, and includes an analysis calculation device 92, an analysis storage device 94, and an analysis input/output device 96. The analysis calculation device 92 achieves various functions by executing programs stored in the analysis storage device 94. For example, the analysis calculation device 92 acquires, through the simulator 20, the log data of the vehicle speed V and the steering angle θs detected by the bench test machine 70, and by comparing the acquired log data with the model data stored in the analysis storage device 94, diagnoses the abnormality in the vehicle 200.

### 1.3. Operation of Vehicle Inspection System 10

The vehicle inspection system 10 operates as follows in a series of inspections. The vehicle 200 is mounted on the inspection table 72. Here, each wheel 224 is mounted on each receiving device 74. Each information output device 50 is disposed to face each external environment sensor 202 of the vehicle 200. The radar transceiver 54 is disposed within a range of a first predetermined distance or more and a second predetermined distance or less from the transmission/reception antenna of the radar 206. The LiDAR transceiver 56 is disposed within a range of a third predetermined distance or more and a fourth predetermined distance or less from the transmission/reception unit of the LiDAR 208. The operator starts to reproduce the virtual external environment by operating the simulator 20 with an operation device (not illustrated). The simulator calculation device 22 reproduces the virtual external environment on the basis of the virtual external environment information 46 stored in the simulator storage device 24.

The vehicle control device 216 of the vehicle 200 detects the virtual information output from the information output device 50, and controls the driving, braking, steering, etc., of the vehicle 200, for example. As change of the rotation speed (vehicle speed V) of the wheels 224 is caused by driving or braking of the vehicle 200, the rotation speed r of the rollers 76 in the receiving device 74 changes. The rotation speed r (vehicle speed V) of the rollers 76 is detected by the vehicle speed sensor 82, and output to the motor control device 88. When the front wheels 224f are displaced due to the steering operation, the displacement quantity d1 (steering angle θs) thereof is detected by the wheel position sensor 84 and output to the motor control device 88. Here, the motor control device 88 calculates the rotation angle θm of the receiving device 74 in accordance with the displacement quantity d1 (steering angle θs) and controls the rotation operation of the receiving device 74. As a result, the receiving device 74 rotates following the steering of the front wheels 224f; therefore, the rotation shaft of the front wheels 224f and the rotation shaft of the rollers 76 can be constantly kept parallel to each other. Thus, the vehicle speed V can be detected accurately. The motor control device 88 outputs the vehicle speed V and the steering angle θs to the simulator 20. The management unit 32 of the simulator 20 outputs the log data (vehicle speed V and steering angle θs) of the vehicle 200 to the analysis device 90 after a series of inspections has been completed.

Incidentally, there are cases where the vehicle 200 is positionally shifted in the vehicle width direction on the receiving device 74 in the inspection. In the occurrence of the positional shift of the vehicle 200, each external environment sensor 202 is also positionally shifted relative to the information output device 50. The positional shift among the radar 206, the LiDAR 208, and the GNSS 210 does not affect the detection information. On the other hand, the positional shift of the camera 204 has a large influence on the detection information (video information).

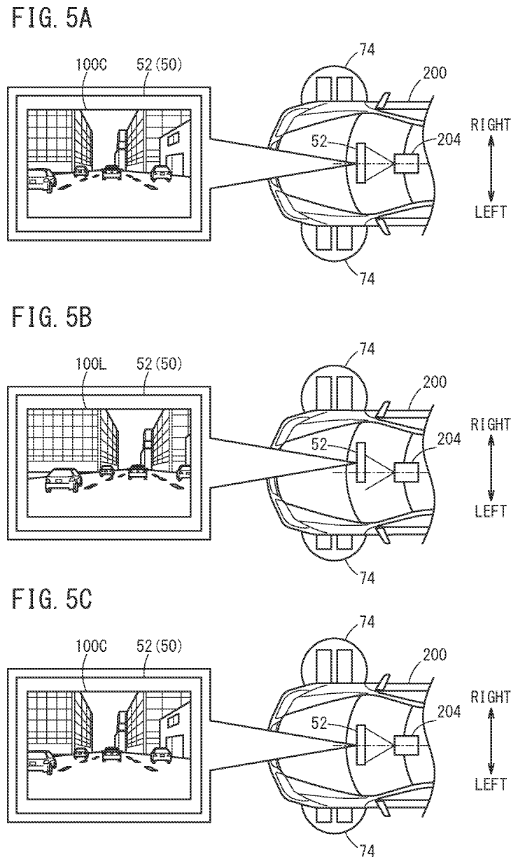

For example, the camera 204 captures an image of a screen range 100C located at a center of the monitor 52 in a state where the vehicle 200 is not positionally shifted as illustrated in FIG. 5A. The camera 204 captures an image of a screen range 100L that is located more leftward than the screen range 100C in a state where the vehicle 200 is positionally shifted to the left as illustrated in FIG. 5B. Then, even though the vehicle 200 is merely positionally shifted on the receiving device 74, the vehicle control device 216 wrongly recognizes that the vehicle 200 is positionally shifted to the left in the virtual external environment and performs erroneous control to return the position of the vehicle 200 to the right.

To prevent such erroneous control, the simulator 20 performs control to shift the position of the monitor 52 in the vehicle width direction. When the vehicle 200 is positionally shifted in the vehicle width direction on the receiving device 74, the positional shift d2 thereof is detected by the vehicle position sensor 86 and output to the simulator 20. The simulator 20 causes the management unit 32 to calculate the rotation quantity of the monitor motor 64 and a necessary power in order to move the monitor 52 by a distance d2 in a direction opposite to the direction of the positional shift of the vehicle 200, and supplies the power to the monitor motor 64 through the input/output device 26. Then, the monitor 52 moves by the distance d2 in the direction opposite to the direction of the positional shift of the vehicle 200. As a result, as illustrated in FIG. 5C, the position state of the monitor 52 and the camera 204 returns to the initial state (state illustrated in FIG. 5A).

### 1.4. Inspection Example

### 1.4.1. Virtual External Environment and Operation of Simulator 20

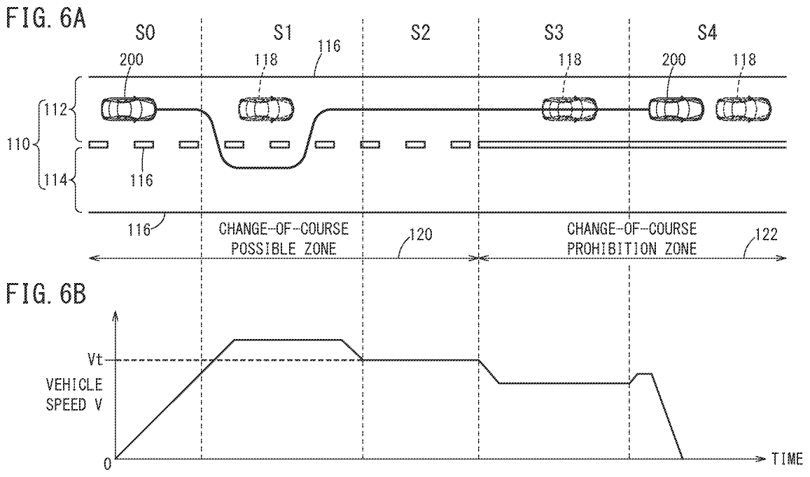

The virtual external environment information 46 stored in the simulator storage device 24 is configured to allow predetermined items to be inspected. For example, as illustrated in FIG. 6A, the virtual external environment information 46 is configured to allow operation of the vehicle 200 concerning the following four items, to be inspected: lane change control (scene S1); lane keeping control (scene S2); adaptive cruise control in traffic jam (scene S3); and collision avoidance control (scene S4). In addition, a starting scene (scene S0) is set in the virtual external environment information 46.

In the scene S0, a situation where the vehicle 200 starts to travel, for example, a situation where the vehicle 200 is at an entrance of an expressway 110, is set. In the scene S1, a situation where the vehicle 200 performs lane change control, for example, a situation where the vehicle 200 travels in a change-of-course possible zone 120 and there exists a preceding vehicle 118 traveling at a target speed Vt or less, ahead of the vehicle 200 in a travel lane 112, is set. In the scene S2, a situation where the vehicle 200 performs lane keeping control, for example, a situation where there exists no preceding vehicle 118 ahead of the vehicle 200 in the travel lane 112, is set. In the scene S3, a situation where the vehicle 200 performs adaptive cruise control in traffic jam, for example, a situation where the vehicle 200 travels in a change-of-course prohibition zone 122 and there exists a preceding vehicle 118 traveling at the target speed Vt or less, ahead of the vehicle 200 in the travel lane 112, is set. In the scene S4, a situation where the vehicle 200 performs collision avoidance control, for example, a situation where the vehicle 200 travels in the change-of-course prohibition zone 122 and there exists a preceding vehicle 118 stopping ahead of the vehicle 200 in the travel lane 112, is set.

The camera simulator 34, the radar simulator 36, the

LiDAR simulator 38, and the GNSS simulator 40 continuously and synchronously reproduce the virtual external environments of the scenes S0 to S4 on the basis of the virtual external environment information 46. Here, on the basis of the operation information of the vehicle 200, the movement trajectory of the vehicle 200 is calculated and the virtual external environment at a position occurring after the vehicle has moved along the trajectory is reproduced.

In the scenes S0 and S2, the camera simulator 34 sequentially generates the video information around the vehicle 200 and outputs the generated video information to the monitor 52. The monitor 52 displays the video corresponding to the video information. The GNSS simulator 40 sequentially generates the longitude and latitude information about the position of the vehicle 200 and outputs the generated longitude and latitude information to the GNSS transmission antenna 58. The GNSS transmission antenna 58 outputs a signal corresponding to the longitude and latitude information. In the scenes S0 and S2, the preceding vehicle 118 or an obstacle is not set, and therefore the radar simulator 36 and the LiDAR simulator 38 do not output the emission instruction to the radar transceiver 54 or the LiDAR transceiver 56.

In the scenes S1, S3, and S4, the camera simulator 34 sequentially generates the video information around the vehicle 200 (including the preceding vehicle 118) and outputs the generated video information to the monitor 52. The monitor 52 displays the video in accordance with the video information. The radar simulator 36 outputs the emission instruction to the radar transceiver 54 so that the radar transceiver 54 emits an electric wave after a radar reflection time has elapsed since the detection of the electric wave of the radar 206 with the radar transceiver 54. The radar reflection time corresponds to a distance between the vehicle 200 and the preceding vehicle 118. In a manner similar to the radar simulator 36, the LiDAR simulator 38 outputs the emission instruction to the LiDAR transceiver 56 so that the LiDAR transceiver 56 emits the light after a scattering light reflection time has elapsed since the detection of the laser light of the LiDAR 208 with the LiDAR transceiver 56. The scattering light reflection time corresponds to a distance between the vehicle 200 and the preceding vehicle 118. The GNSS simulator 40 sequentially generates the longitude and latitude information about the position of the vehicle 200, and outputs the information to the GNSS transmission antenna 58. The GNSS transmission antenna 58 outputs the signal corresponding to the longitude and latitude information.

In the scene S1, if the external environment sensors 202, the vehicle control device 216, and the steering device 220 of the vehicle 200 operate correctly, the vehicle control device 216 causes the vehicle 200 to perform the lane change. In the lane change, the steering angle θs of the vehicle 200 is changed. The gyro simulator 42 calculates the angular speed or the angular acceleration in the turning direction that is expected to occur in the vehicle 200 that actually travels, on the basis of the vehicle speed V and the steering angle θs, and outputs the result to the gyroscope 212.

Incidentally, the detectable distance to a target object, i.e., the detectable distance to the preceding vehicle 118 in this case, differs between the camera 204, the radar 206, and the LiDAR 208. In general, the detectable range of the radar 206 is the longest, and the detectable range of the LiDAR 208 is the shortest. Therefore, when the inter-vehicular distance L between the vehicle 200 and the preceding vehicle 118 has become less than or equal to a detectable range L1 of the radar 206, the radar simulator 36 outputs the emission instruction to the radar transceiver 54. In addition, when the inter-vehicular distance L between the vehicle 200 and the preceding vehicle 118 has become less than or equal to a detectable range L2 (<L1) of the camera 204, the camera simulator 34 outputs the video information of the preceding vehicle 118 to the monitor 52. In addition, when the inter-vehicular distance L between the vehicle 200 and the preceding vehicle 118 has become less than or equal to a detectable range L3 (<L2) of the LiDAR 208, the LiDAR simulator 38 outputs the emission instruction to the LiDAR transceiver 56.

### 1.4.2. Travel Operation of Vehicle 200

In a case where the virtual external environment illustrated in FIG. 6A is reproduced, the vehicle speed V of the vehicle 200 transitions ideally as illustrated in FIG. 6B.

In the scene S0, the vehicle control device 216 recognizes that the vehicle 200 travels on the expressway 110 that is reproduced. Here, the vehicle control device 216 causes the vehicle 200 to accelerate from the vehicle speed V=0 to the target speed Vt of the expressway 110.

In the scene S1, the vehicle control device 216 recognizes the preceding vehicle 118 that travels at the target speed Vt or less and recognizes that the travel position of the vehicle 200 is in the change-of-course possible zone 120. At this time, the vehicle control device 216 causes the vehicle 200 to change the lane to a passing lane 114 in order to overtake the preceding vehicle 118. The vehicle control device 216 determines that the zone is a change-of-course possible zone 120, based on a lane mark 116 that is photographed by the camera 204. The vehicle control device 216 causes the vehicle 200 to accelerate before the overtaking, travel at constant speed at the overtaking, and decelerate after the overtaking.

In the scene S2, the vehicle control device 216 recognizes that there exists no preceding vehicle 118 ahead of the vehicle 200. At this time, the vehicle control device 216 causes the vehicle 200 to travel at the target speed Vt.

In the scene S3, the vehicle control device 216 recognizes the preceding vehicle 118 that travels at the target speed Vt or less, and recognizes that the travel position of the vehicle 200 is in the change-of-course prohibition zone 122. At this time, the vehicle control device 216 performs the adaptive cruise control in traffic jam. The vehicle control device 216 determines that the zone is a change-of-course prohibition zone 122, based on the lane mark 116 photographed by the camera 204. The vehicle control device 216 causes the vehicle 200 to travel at the same vehicle speed V as the preceding vehicle 118, and keep the inter-vehicle distance L between the vehicle 200 and the preceding vehicle 118.

In the scene S4, the vehicle control device 216 recognizes the preceding vehicle 118 that has stopped. At this time, the vehicle control device 216 causes the vehicle 200 to decelerate and stop behind the preceding vehicle 118.

### 1.4.3. Analysis by Analysis Device 90

The simulator 20 reproduces the virtual external environments in the scenes S0 to S4, inputs the operation information (vehicle speed V, steering angle θs) of the vehicle 200 output from the bench test machine 70, and records the log data in the simulator storage device 24. After the inspection ends, the simulator 20 outputs the log data to the analysis device 90. The analysis device 90 stores ideal model data as illustrated in FIG. 6B in advance, and compares the log data with the model data. If the degree of coincidence between the log data and the model data is more than or equal to a predetermined value, the analysis device 90 determines that the external environment sensors 202, the vehicle control device 216, the driving device 218, the braking device 222, and the steering device 220 in the vehicle 200 are normal. If the degree of coincidence between the two data is less than the predetermined value, the analysis device 90 determines that one or some of these devices has abnormality.

### 2. Second Embodiment

For the convenience of description, the vehicle 200 includes one radar 206 and one LiDAR 208 in the first embodiment. However, actually, the vehicle 200 includes a plurality of radars 206 and a plurality of LiDARs 208. In a case of arranging the radar transceiver 54 and the LiDAR transceiver 56 for the multiple radars 206 and the multiple LiDARs 208, configuring the radar transceiver 54 and the LiDAR transceiver 56 to be movable improves the inspection efficiency. The second embodiment is related to a simulator unit 300 that integrates part of the information output devices 50 and part of the functions of the simulator 20 so as to be movable.

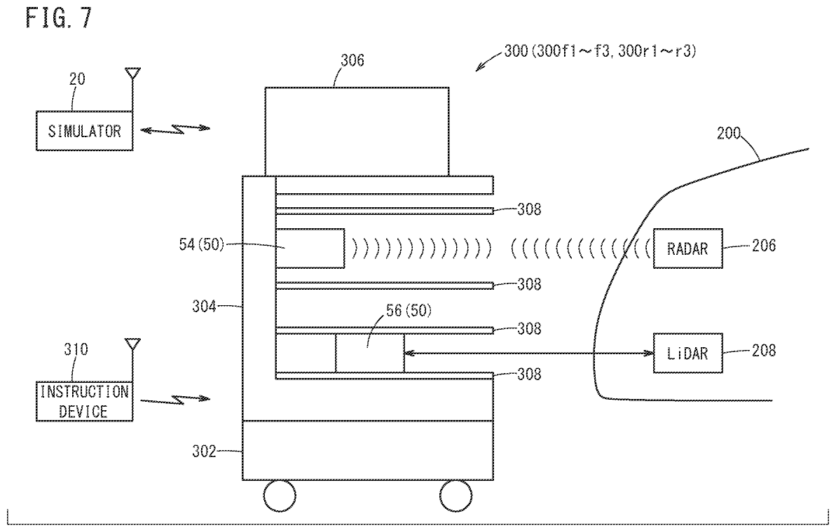

A specific example of the simulator unit 300 is described with reference to FIG. 7. In the simulator unit 300 illustrated in FIG. 7, the radar simulator 36 and the radar transceiver 54 in the first embodiment are integrated so as to be movable, and the LiDAR simulator 38 and the LiDAR transceiver 56 in the first embodiment are integrated so as to be movable. Note that the simulator calculation device 22 has the same functions excluding the radar simulator 36 and the LiDAR simulator 38. The simulator unit 300 includes a mobile robot 302, a height adjustment robot 304, the radar transceiver 54, the LiDAR transceiver 56, and a mobile simulator 306.

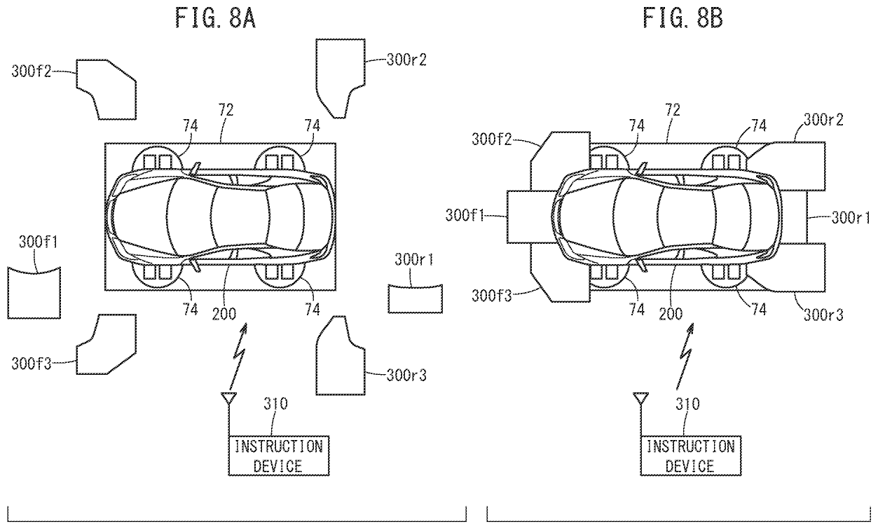

The mobile robot 302 includes a movement mechanism, a controller, a storage device, and a communication device, and has a function of moving on the work floor. The mobile robot 302 stores in advance a movement course set on the work floor, and moves along the movement course in accordance with a movement instruction transmitted from an external instruction device 310. In the movement course, a standby position (FIG. 8A) at which each unit is located away from the inspection table 72 and an inspection position (FIG. 8B) at which each unit is located near the inspection table 72 correspond respectively to a start point and an end point. In a case of inspecting a plurality of kinds of vehicles 200, the position to inspect the vehicle 200 is different depending on the size and shape of the vehicle 200. Thus, the mobile robot 302 stores a plurality of movement courses and selects a movement course in accordance with course information instructed by the instruction device 310.

The height adjustment robot 304 includes a height adjustment mechanism, a controller, a storage device, and a communication device, and has a function of supporting the radar transceiver 54 and the LiDAR transceiver 56 and a function of adjusting the height positions of the radar transceiver 54 and the LiDAR transceiver 56. The radar transceiver 54 and the LiDAR transceiver 56 are separated in the vertical direction by partition plates 308. The partition plates 308 disposed in the vertical direction of the radar transceiver 54 are covered with an electric wave absorber, and the partition plates 308 disposed in the vertical direction of the LiDAR transceiver 56 are covered with a light absorber. In addition, the periphery of the radar transceiver 54 and the LiDAR transceiver 56 is also covered with the respective absorbers. The height adjustment robot 304 stores the height of each of the radar 206 and the LiDAR 208 for each vehicle type, and adjusts the height of each of the radar transceiver 54, the LiDAR transceiver 56, and the partition plate 308, in accordance with the information about the vehicle type instructed from the instruction device 310.

The mobile simulator 306 has the same function as the radar simulator 36 and the LiDAR simulator 38 in the simulator 20 illustrated in FIG. 3. The mobile simulator 306 includes a short-range communication device, and can perform data communication with the simulator 20. The mobile simulator 306 receives the virtual external environment information 46 stored in the simulator storage device 24, and is integrally controlled by the management unit 32 on the simulator 20 side.

The arrangement of the simulator units 300 is described with reference to FIG. 8A and FIG. 8B. In the description below, the vehicle 200 includes the radars 206 and the LiDARs 208 at four corners and the radars 206 at the front center and the rear center.

As illustrated in FIG. 8A, each of simulator units 300f1, 300f2, 300f3, 300r1, 300r2, and 300r3 is set at the standby position before the vehicle 200 is inspected. The standby position is set leaving a sufficient space at the entry path for the vehicle 200 so that the vehicle 200 can advance to the inspection table 72.

As illustrated in FIG. 8B, the instruction device 310 transmits the course information in accordance with the vehicle type, to the simulator units 300f1, 300f2, 300f3, 300r1, 300r2, and 300r3 when the vehicle 200 is inspected. The simulator units 300f1, 300f2, 300f3, 300r1, 300r2, and 300r3 move along the movement courses in accordance with the course information, and reach the respective inspection positions.

The display device may be a projector and a screen instead of the monitor 52.

### 3. Technical Concept Obtained from Embodiments

The technical concept that is obtained from the above embodiments and modifications is hereinafter described.

The present invention provides the vehicle inspection system 10 configured to inspect the operation of the vehicle 200 that performs the travel control on the basis of the external environment information detected by the plurality of external environment sensors 202, the vehicle inspection system 10 including: the simulator 20 configured to reproduce the virtual information simulating the external environment information; the plurality of information output devices 50 provided for the respective external environment sensors 202 and configured to cause the respective external environment sensors 202 to detect the virtual information reproduced by the simulator 20; and the bench test machine 70 configured to detect the operation of the vehicle 200 that performs the travel control on the basis of the virtual information, wherein the simulator 20 is configured to output the virtual information corresponding to the same virtual external environment, to the information output devices 50, and synchronize the virtual information to be output to the information output devices 50.

By the above structure, the operation of the vehicle 200 (vehicle speed V, steering angle θs) is detected by causing the external environment sensors 202 of the vehicle 200 to detect the virtual information actually. Thus, the external environment sensors 202, the vehicle control device 216, and the various actuators provided to the driving device 218, the braking device 222, and the steering device 220 can be consistently inspected. In addition, the external environment sensors 202 are caused to detect the virtual information corresponding to the same virtual external environment. Thus, the non-synchronous operation of the external environment sensors 202 can be found easily and the erroneous assembling of the external environment sensors 202 can be found easily.

In the present invention, the external environment sensors 202 may include the camera 204; the information output devices 50 may include the monitor (display device) 52; the monitor 52 may cause the camera 204 to photograph the video of the virtual external environment; and the information output device 50 excluding the monitor 52 may cause the external environment sensors 202 excluding the camera 204 to detect the virtual information that is synchronization with the video.

With the above structure, the virtual external environment is displayed on the monitor 52, and the operator can thus recognize the inspection content.

In the present invention, the bench test machine 70 may include the receiving device 74 configured to receive the operation of the wheel 224 of the vehicle 200 that is placed on the receiving device 74.

With the above structure, the vehicle 200 can be inspected on the inspection table 72 and the test course where the vehicle 200 actually travels is unnecessary; thus, a large space is unnecessary. As a result, the vehicle 200 can be inspected indoors. The indoor inspection is not affected by the weather, and thus the inspection accuracy improves. Moreover, the inspection under the same condition can be reproduced.

In the present invention, the information output device 50 and the simulator 20 that outputs the virtual information to the information output device 50 may be the unit (simulator unit 300) that is movable, and the unit (simulator unit 300) may be disposed at the position facing each of the external environment sensors 202 when the vehicle 200 is inspected.

By the above structure, the unit (simulator unit 300) is configured to be movable, and thus it is possible to flexibly deal with various types of vehicles or various specifications of equipment.

The vehicle inspection system according to the present invention is not limited to the aforementioned embodiments and various structures are possible without departing from the essence and gist of the present invention.

What is claim is:

1. A vehicle inspection system configured to inspect operation of a vehicle that performs travel control based on external environment information detected by a plurality of external environment sensors, the vehicle inspection system comprising:
a simulator configured to reproduce virtual information simulating the external environment information;
a plurality of information output devices provided respectively for the plurality of external environment sensors and configured to cause the respective external environment sensors to detect the virtual information reproduced by the simulator; and
a bench test machine configured to detect the operation of the vehicle that performs the travel control based on the virtual information,
wherein the simulator is configured to output the virtual information corresponding to a same virtual external environment, to the plurality of information output devices, and configured to synchronize the virtual information to be output to the plurality of information output devices.

2. The vehicle inspection system according to claim 1, wherein:
the plurality of external environment sensors include a camera;
the plurality of information output devices include a display device;
the display device causes the camera to photograph a video of the virtual external environment; and
the information output device excluding the display device is configured to cause the external environment sensors excluding the camera to detect the virtual information that is synchronization with the video.

3. The vehicle inspection system according to claim 1, wherein the bench test machine includes a receiving device configured to receive operation of a wheel of the vehicle that is placed on the receiving device.

4. The vehicle inspection system according to claim 1, wherein:
the information output device and the simulator that outputs the virtual information to the information output device are a unit configured to be movable; and
the unit is disposed at a position facing each of the external environment sensors when the vehicle is inspected.
